(19) United States
(12) Patent Application Publication
(10) Pub. No.: US 2022/0122174 A1
(43) Pub. Date: Apr. 21, 2022

(54) METHOD AND APPARATUS FOR PEER-TO-PEER ENERGY SHARING BASED ON REINFORCEMENT LEARNING

(71) Applicant: National Tsing Hua University, Hsinchu City (TW)

(72) Inventors: Tsan-Po Huang, Hsinchu City (TW); Wei-Yu Chiu, Hsinchu City (TW)

(73) Assignee: National Tsing Hua University, Hsinchu City (TW)

(21) Appl. No.: 17/123,156

(22) Filed: Dec. 16, 2020

(30) Foreign Application Priority Data
Oct. 21, 2020 (TW) 109136558

(51) Int. Cl. G06Q 40/04; G06N 20/00; G06N 5/04; G06Q 50/06; G06Q 10/06; H02J 3/00

(52) U.S. Cl. CPC G06Q 40/04; G06N 20/00; G06N 5/04; G06Q 50/06; H02J 2310/12; G06Q 10/06315; H02J 3/008; H02J 2203/20; G06Q 10/067

(57) ABSTRACT

An apparatus and a method for peer-to-peer energy sharing based on reinforcement learning are provided. The method includes following steps: uploading trading electricity in a future time slot to a coordinator device and receiving global trading information obtained by the coordinator device integrating trading electricity of each user device; defining power states according to the global trading information, self electricity information, and an internal electricity price and estimating electricity costs of trading electricity under each power state to generate a reinforcement learning table; building a planning model according to the global trading information and estimating electricity costs of trading electricity of multiple time slots under each power state in a simulated environment by the planning model to update the reinforcement learning table; and estimating trading electricity to be arranged under a current power state by using the reinforcement learning table and uploading the same to the coordinator device for trading.

### CROSS-REFERENCE TO RELATED APPLICATION

This application claims the priority benefit of Taiwan application serial no. 109136558, filed on Oct. 21, 2020. The entirety of the above-mentioned patent application is hereby incorporated by reference herein and made a part of this specification.

### BACKGROUND

### Technical Field

The disclosure relates to a method and apparatus for reinforcement learning, and in particular, to a method and an apparatus for peer-to-peer energy sharing based on reinforcement learning.

### Description of Related Art

In recent years, the number of homes using household renewable energy system increases, so that how to make good use of renewable energy and minimize the costs of household electricity has become an important issue. Most conventional peer-to-peer energy sharing algorithms adopt a centralized algorithm in which the coordinator uniformly obtains the electricity consumption data of all households for distribution, thus excluding a master control of each household for energy management.

In an effort to solve this problem, some documents have proposed the use of distributed algorithms to dispel such doubt. Nevertheless, this algorithm requires the use of the iterative bidding method to allow each household to solve the optimization problem independently, and a result will cause a considerable amount of communications among apparatuses, which may increase the burden of communication equipment in the energy-sharing region, and even the result may not converge, resulting in poor performance of the energy management systems.

### SUMMARY

The disclosure provides a method and an apparatus for peer-to-peer energy sharing based on reinforcement learning capable of solving the problem of network burden caused by a large number of communications in the conventional method for peer-to-peer energy sharing.

The disclosure provides a method for peer-to-peer energy sharing based on reinforcement learning adapted to determine trading electricity by a designated user device among a plurality of user devices in an energy-sharing region. The method includes the following steps: uploading a trading electricity in a future time slot predicted according to self electricity information to a coordinator device in the energy-sharing region and receiving global trading information obtained by the coordinator device integrating trading electricity uploaded by each user device; defining a plurality of power states according to the global trading information, the electricity information, and an internal electricity price of the energy-sharing region, and estimating electricity costs of trading electricity arranged under each of the power states to generate a reinforcement learning table; building a planning model by using the global trading information, and updating the planning model by using incremental implementation; estimating electricity costs of trading electricity in a plurality of future time slots arranged under each of the power states in a simulated environment generated by the planning model to update the reinforcement learning table until the estimated electricity costs converge to a predetermined interval; predicting trading electricity suitable to be arranged under a current power state by using the reinforcement learning table, and uploading the trading electricity to the coordinator device for trading.

The disclosure provides a method for peer-to-peer energy sharing based on reinforcement learning adapted to determine trading electricity by a designated user device among a plurality of user devices in an energy-sharing region. The method includes the following steps: defining a plurality of power states according to self electricity information and an internal electricity price of the energy-sharing region, predicting trading electricity in a future time slot according to the electricity information, and estimating electricity costs of trading electricity arranged under each of the power states to generate a reinforcement learning table; uploading the reinforcement learning table to a coordinator device in the energy-sharing region, and receiving a federated reinforcement learning table and a global trading information obtained by the coordinator device integrating reinforcement learning tables uploaded by all user devices; building a planning model by using the global trading information, and updating the planning model by using incremental implementation; estimating electricity costs of trading electricity in a plurality of future time slots arranged under each of the power states in a simulated environment generated by the planning model, and updating the reinforcement learning table by using the electricity costs and the federated reinforcement learning table until the estimated electricity costs converge to a predetermined interval; and predicting trading electricity suitable to be arranged under a current power state by using the reinforcement learning table, and uploading the trading electricity to the coordinator device for trading.

The disclosure further provides an apparatus for peer-to-peer energy sharing based on reinforcement learning, and the apparatus includes a connection device, a storage device, and a processor. Herein, the connection device is a coordinator device configured to manage a plurality of user devices in an energy-sharing region. The storage device is configured to store a computer program. The processor is coupled to the connection device and the storage device and is configured to define a plurality of power states according to at least one of self electricity information, an internal electricity price of the energy-sharing region, and global trading information received from the coordinator device, predict trading electricity in a future time slot according to the electricity information, and estimate electricity costs of the trading electricity arranged under each of the power states to generate a reinforcement learning table. The global trading information is obtained by the coordinator device by integrating trading electricity uploaded by each of the user devices. The processor is configured to build a planning model by using the global trading information and update the planning model by using incremental implementation. In a simulated environment generated by the planning model, the processor is configured to estimate electricity costs of trading electricity in a plurality of future time slots arranged under each of the power states and update the reinforcement learning table by using at least one of the electricity costs and the federated reinforcement learning table until the estimated electricity costs converge to a predetermined interval. The federated reinforcement learning table is obtained by the coordinator device integrating reinforcement learning tables uploaded by all user devices. The processor is configured to predict trading electricity suitable to be arranged under a current power state by using the reinforcement learning table and upload the trading electricity to the coordinator device for trading.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a system for peer-to-peer energy sharing according to an embodiment of the disclosure.

FIG. 2 is a block diagram illustrating an apparatus for peer-to-peer energy sharing based on reinforcement learning according to an embodiment of the disclosure.

FIG. 3 is a flow chart illustrating a method for peer-to-peer energy sharing based on reinforcement learning according to an embodiment of the disclosure.

FIG. 4 is a flow chart illustrating a method for peer-to-peer energy sharing based on reinforcement learning according to an embodiment of the disclosure.

### DESCRIPTION OF THE EMBODIMENTS

In the embodiments of the disclosure, dynamic learning is applied to each residence. According to the trading information from outside, a model-based multi-agent reinforcement learning algorithm or a federated reinforcement learning method is used to arrange electricity trading of each residence through iterative updating and planning a time schedule for a length of time slot. In this way, the cost of household electricity may be minimized, and privacy and low communication frequency are achieved.

A method for peer-to-peer energy sharing based on reinforcement learning provided by the embodiments of the disclosure is divided into three stages described as follows. A first stage is rehearsal trading. Each of the user devices pre-arranges the amount of electricity to be traded in a future time slot and provides the same to a coordinator device that integrates the amount of electricity into global trading information (a cash flow and an electricity flow are not generated at this stage). A second stage is planning. Each of the user devices builds a planning model by using the global trading information returned by the coordinator device and performs learning and updating locally through incremental implementation. A third stage is actual trading. Each of the user devices arranges trading electricity in the future time slot, selects the electricity to be traded with a better expected value by using the built model and uploads the same to the coordinator device for trading (the cash flow, the electricity flow, and a data flow are generated at this stage).

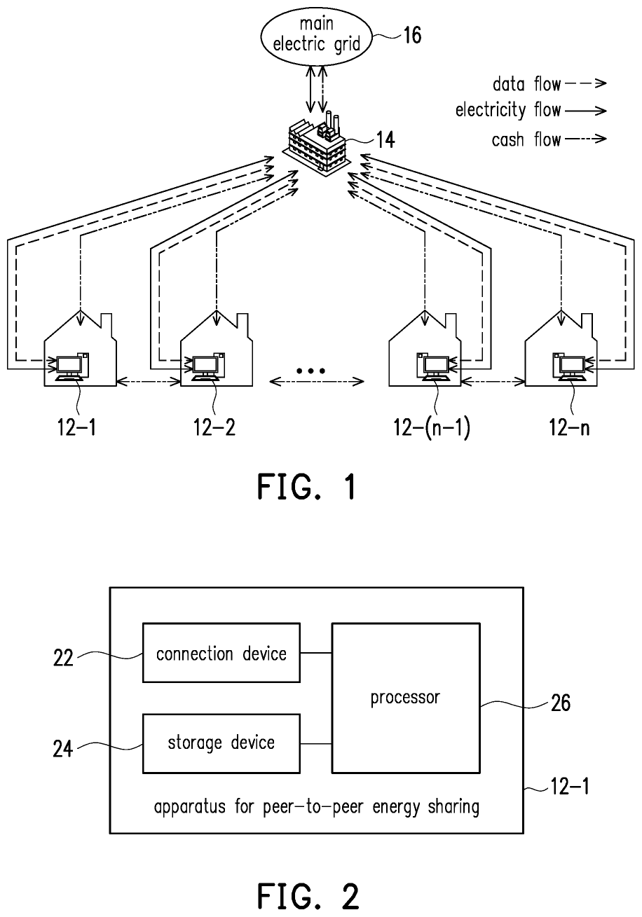

In details, FIG. 1 is a schematic diagram illustrating a system for peer-to-peer energy sharing according to an embodiment of the disclosure. With reference to FIG. 1, a system for peer-to-peer energy sharing 1 provided by the embodiments of the disclosure includes a plurality of user devices 12-1 to 12-n located in an energy-sharing region (e.g., a plurality of households in the same community), where n is a positive integer. Each of the user devices 12-1 to 12-n is provided with, for example, a power generation system, an energy storage system (ESS), and an energy management system (EMS). Each of the user devices 12-1 to 12-n may play a role of an energy producer and consumer at the same time, and may provide electricity to other user devices or receive electricity from other user devices in the energy-sharing region. The power generation system includes, but not limited to, a solar power generation system, wind power generation system, etc. Each of the user devices 12-1 to 12-n is, for example, connected to a coordinator device 14, which assists in the management of electricity distribution among the user devices 12-1 to 12-n so as to obtain electricity from a main electric grid 16 when electricity of the user devices 12-1 to 12-n is insufficient or provide excessive electricity to the main electric grid 16 when electricity of the user devices 12-1 to 12-n is surplus.

The embodiments of the disclosure provide a model-based method for peer-to-peer energy sharing of multi-agent reinforcement learning, which enables each of intelligent agents (i.e., the user devices 12-1 to 12-n) to predict electricity suitable to be traded in a future time slot according to its own electricity information (including generated electricity, consumed electricity, and stored electricity) through reinforcement learning. In this way, the intelligent agents may quickly adapt to the environment and reduce the number of communications with other apparatuses.

FIG. 2 is a block diagram illustrating an apparatus for peer-to-peer energy sharing based on reinforcement learning according to an embodiment of the disclosure. With reference to FIG. 1 and FIG. 2 together, the user device 12-1 provided in FIG. 1 is taken as an example to describe the apparatus for peer-to-peer energy sharing provided by the embodiments of the disclosure. In other embodiments, the apparatus for peer-to-peer energy sharing may also be another user device in FIG. 1. The apparatus for peer-to-peer energy sharing 12-1 is a computing apparatus with a computing capability such as a file server, a database server, an application server, a workstation, or a personal computer, and includes devices such as a connection device 22, a storage device 24, and a processor 26. Functions of these devices are described as follows.

The connection device 22 is, for example, any wired or wireless interface device connected to the coordinator device 14, and may upload self trading electricity or a reinforcement learning table of the apparatus for peer-to-peer energy sharing 12-1 to the coordinator device 14 and receive global trading information or a federated reinforcement learning table returned by the coordinator device 14. Regarding the wired manner, the connection device 22 may be, but not limited to, an interface such as a universal serial bus (USB), an RS232, a universal asynchronous receiver/transmitter (UART), an internal integrated circuit (I2C), a serial peripheral interface (SPI), a display port, or a thunderbolt. Regarding the wireless manner, the connection device 22 may be, but not limited to, a device supporting a communication protocol such as wireless fidelity (Wi-Fi), RFID, Bluetooth, infrared, near-field communication (NFC), or device-to-device (D2D). In some embodiments, the connection device 22 may also include a network card supporting Ethernet or supporting wireless network standards such as 802.11g, 802.11n, 802.11ac, etc., such that the apparatus for peer-to-peer energy sharing 12-1 may be connected to the coordinator device 14 through a network so as to upload or receive electricity trading information.

The storage device 24 is, for example, any type of fixed or movable random access memory (RAM), read-only memory (ROM), flash memory, hard disk or similar device, or a combination of the foregoing devices, and is configured to store a computer program which may be executed by the processor 26. In some embodiments, the storage device 24 may store, for example, the reinforcement learning table generated by the processor 26 and the global trading information or the federated reinforcement learning table received by the connection device 22 from the coordinator device 14.

The processor 26 is, for example, a central processing unit (CPU) or a programmable microprocessor for general or special use, a microcontroller, a digital signal processor (DSP), a programmable controller, an application specific integrated circuit (ASIC), a programmable logic device (PLD), other similar devices, or a combination of the foregoing devices, which is not particularly limited by the disclosure. In this embodiment, the processor 26 may load the computer program from the storage device 24 to execute the method for peer-to-peer energy sharing based on reinforcement learning provided by the disclosure.

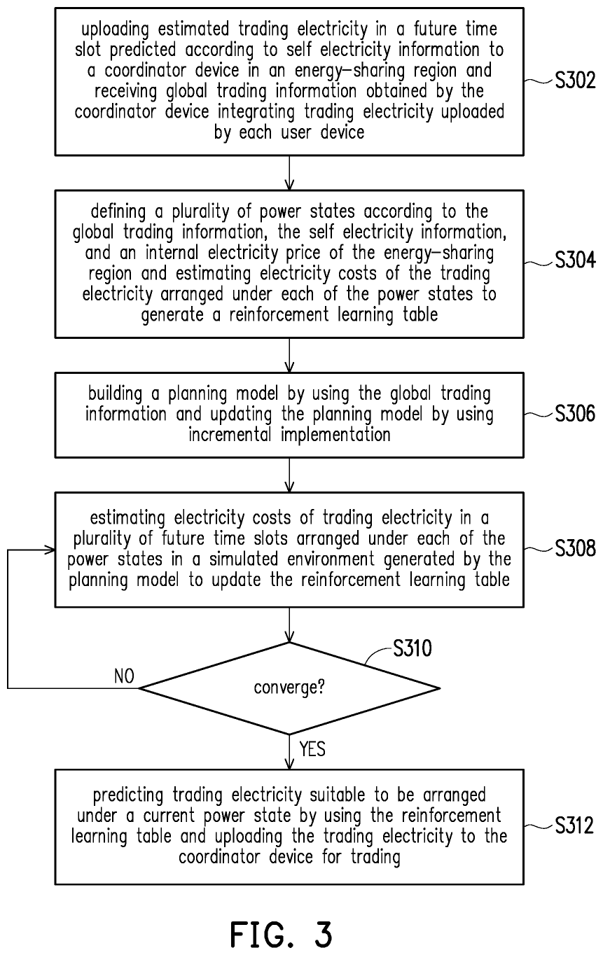

FIG. 3 is a flow chart illustrating a method for peer-to-peer energy sharing based on reinforcement learning according to an embodiment of the disclosure. With reference to FIG. 1, FIG. 2, and FIG. 3 together, the method provided by this embodiment is adapted for the apparatus for peer-to-peer energy sharing 12-1, and the steps of the method for peer-to-peer energy sharing provided by this embodiment is described in detail below together with the devices of the apparatus for peer-to-peer energy sharing 12-1.

In step S302, the processor 26 of the apparatus for peer-to-peer energy sharing 12-1 uploads trading electricity in a future time slot predicted according to self electricity information to the coordinator device 14 in the energy-sharing region and receives global trading information obtained by the coordinator device 14 integrating trading electricity uploaded by each of the user devices 12-1 to 12-n through the connection device 22. Herein, the processor 26 estimates the trading electricity (purchased electricity or sold electricity) in the future time slot according to electricity information, such as self generated electricity, consumed electricity, and stored electricity, and uploads the trading electricity to the coordinator device 14. The coordinator device 14 may, for example, calculate a sum of electricity sales and a sum of electricity purchases of all user devices 12-1 to 12-n or treat a trading sum obtained by adding the two as the global trading information to be returned to the apparatus for peer-to-peer energy sharing 12-1. In some embodiments, the coordinator device 14 may further, for example, estimate required electricity costs of arranging the trading electricity and treat the estimated electricity costs, the sum of electricity sales, and the sum of electricity purchases, and an internal electricity price as the global trading information to be returned to the apparatus for peer-to-peer energy sharing 12-1.

In step S304, the processor 26 defines a plurality of power states according to the global trading information, the self electricity information, and the internal electricity price of the energy-sharing region and estimates electricity costs of the trading electricity arranged under each of the power states to generate a reinforcement learning table. Herein, the electricity information includes, but not limited to, generated electricity, consumed electricity, and stored electricity (i.e., battery electricity).

To be specific, the processor 26, for example, gives a state space S and an action space A, marks a state in a time slot t as sₜ, where, sₜ ϵS, and marks an action selected in the state sₜ in the time slot t as aₜ, where aₜ ϵA. After the action aₜ is selected in the state sₜ, this environment is transformed to a next state sₜ₊₁, and a cost Cost(t) is produced. Herein, a probability function of selecting the action aₜ in the state sₜ may be marked as a strategy π(sₜ), and an action value function q_{π}(sₜ, aₜ) configured to evaluate an expected value of a cumulative cost of using the strategy π in the time slot t may be defined as:

q_{π}(sₜ,aₜ)=E_{π}[Σⱼ₌ₜ₊₁^{T}γ^{j-t-1}Costⱼ₋₁|sₜ,aₜ],∀sₜϵS,∀a_{t ϵA}

Herein, γ is a discount factor. The optimization problem of each user device is to find an optimal strategy π_{*} which may minimize the expected value of the cumulative cost, and an optimized action value function may be marked as q_{*(}sₜ, aₜ).

In an embodiment, the processor 26 defines, for example, a state s_{t,i} of an i^{th} user device in the time slot t as:

s_{t,i}=[Pₙₑₜ^{agg}(t−1),ξₛₑₗₗ(t−1),E_{b,i}(t−1),P_{c,i}(t),P_{renewable,i}(t)]

Herein, Pₙₑₜ^{agg}(t−1)=P_{buy}^{agg}(t−1)−Pₛₑₗₗ^{agg}(t−1) is a cumulative total trading electricity of the energy-sharing region in a time slot t−1, where Pₛₑₗₗ^{agg}(t−1) is the sum of sold electricity and P_{buy}^{agg}(t−1) is the sum of purchased electricity (i.e., the global trading information). When Pₙₑₜ^{agg}(t) is positive, it means that the energy-sharing region lacks electricity, and when Pₙₑₜ^{agg}(t) is negative, it means that the energy-sharing region has surplus electricity which may be outputted to the main electric grid 16. The total trading electricity Pₙₑₜ^{agg}(t−1) acts as an observation indicator to facilitate learning of an effect of actions of other user devices by the user device, and learning efficiency may also be improved. In addition, the parameter ξₛₑₗₗ(t−1) is the internal electricity price of the energy-sharing region, E_{b,i}(t−1) is the stored electricity (i.e., battery electricity) of the i^{th} user device, P_{c,i}(t) is the consumed electricity of the i^{th} user device, and P_{renewable,i}(t) is the generated electricity of the i^{th} user device. These parameters may facilitate learning of environmental changes by the user device.

Each user device may determine electricity to be traded, so that the action of the user device may be defined as:

a_{t,i}=[P_{c,i}(t)]

Herein, when P_{c,i}(t) is positive, it means that the user device intends to purchase electricity, and when P_{c,i}(t) is negative, it means that the user device intends to sell electricity.

With reference to the flow process provided in FIG. 3 again, in step S306, the processor 26 builds a planning model by using the “global trading information” returned by the coordinator device 14 and performs updating by using incremental implementation. The planning model is configured to accelerate learning and may reduce a number of communication cycles to two.

To be specific, the processor 26 makes the planning model approximate the global trading information Pₛₑₗₗ^{agg}(t) and P_{buy}^{agg}(t) so as to locally learn the optimal strategy. Herein, the processor 26 uses predicted information including generation and consumption of renewable electricity (including P_{renewable}(t) and P_{c,i}(t)) and calculates a predicted energy level E_{b,i}(t) of a battery.

Herein, a planning model Mo del (P_{renewable}(t)) approximates a vector [Pₛₑₗₗ^{agg}(t), P_{buy}^{agg} (t)] when a renewable electricity prediction P_{renewable}(t) is given. This planning model Model(P_{renewable}(t)) may be updated by using the incremental implementation, and the formula is provided as follows:

Model(P_{renewable}(t))←Model(P_{renewable}(t))+σ([Pₛₑₗₗ^{agg}(t),P_{buy}^{agg}(t)]−Model(P_{renewable}(t))

Herein, [Pₛₑₗₗ^{agg}(t),P_{buy}^{agg}(t)] is the global trading information received from the coordinator device 14, which includes a sum of sold electricity Pₛₑₗₗ^{agg}(t) and a sum of purchased electricity P_{buy}^{agg}(t). In addition, a step parameter σϵ(0,1] is a constant.

It is noted that, at the beginning of the algorithm, the user device 12-1 may, for example, execute a rehearsal trading for next 24 hours to build the planning model of the user device 12-1. In this stage, the user device 12-1 may not actually output or input electricity, and instead, the user device 12-1 only broadcasts the required trading electricity and receive the global trading information from the coordinator device 14. This process requires only one communication cycle.

With reference to the flow process of FIG. 3 again, in step S308, the processor 26 executes a planning procedure to estimate electricity costs of trading electricity of a plurality of future time slots arranged under each power state in a simulated environment generated by the planning model and accordingly updates the reinforcement learning table.

To be specific, the planning procedure is designed to update the reinforcement learning table before actual trading. This planning procedure is locally executed, so that network congestion caused by excessive communication may be avoided. Through the planning model built in the rehearsal trading and the previous information of a cost model, the user device may learn an estimation experience. Thanks to the openness and transparency of the cost model, the user device may estimate a purchased electricity price and a sold electricity price according to the global trading information so as to calculate the cost Costᵢ(t). For instance, the updated formula of a learning value Qᵢ of the reinforcement learning table of the i^{th} user device is provided as follows:

$${Q}_{i} ( {s}_{t , i} , {a}_{t , i} ) ← ( 1 - α ) \cdot {Q}_{i} ( {s}_{t , i} , {a}_{t , i} ) + α \cdot \{ {Cost}_{i} ( t ) + γ \cdot {max}_{a} {Q}_{i} ( {s}_{t + 1 , i} , a ) \}$$

Herein, α is a learning rate, γ is a discount factor, and Qᵢ(s_{t+1,i},a) is a learning value obtained by arranging trading electricity a under a power state s_{t+1,i}. Among plural types of trading electricity a which may be arranged in the power state s_{t,i}, the trading electricity a having a maximum learning value acts as an optimal trading electricity a*, and the estimated electricity cost Costᵢ(t) of arranging this optimal trading electricity a* to the new power s_{t+1,i} are fed back to the learning value of the trading electricity a corresponding to the original power state s_{t,i}. The learning rate α is, for example, any number between 0.1 and 0.5 and may be used to determine an influence ratio of the new power state s_{t+1,i} to the learning value of the original power state s_{t,i}. The discount factor γ is, for example, any number between 0.9 and 0.99 and may be used to determine a ratio of the learning value of the new power state s_{t+1,i} to the fed-back electricity cost Costᵢ(t).

It is noted that in a planning stage, the processor 26 may, for example, bring some noise into the global trading information and the trading electricity, so that an optimal solution is prevented from falling into a local minimum, and this step may allow the estimated trading electricity to be suitably applied to the real environment.

To be specific, the processor 26, for example, selects the optimal solution based on a specific probability and selects other solutions based on a remaining probability so as to update the reinforcement learning table.

In an embodiment, the processor 26 adopts, for example, an c-greedy method to perform exploration with a specific probability and perform exploitation with most probabilities to arrange the electricity to be traded in each time slot, and the formula is provided as follows:

$${π}_{ɛ} ( {a}_{t} ) = \{ \begin{matrix}1 - ɛ , & if {a}_{t} = {a}_{t}^{*} \\ ɛ , & others\end{matrix}$$

Herein, an optimal solution a*ₜ of the action aₜ is obtained through the following formula:

arg minₐQ(sₜ,a)

limited by aₜ^{lower}≤a≤aₜ^{upper}

Herein, aₜ^{lower} and aₜ^{upper} are a lower limit and an upper limit of the action a.

In another embodiment, the processor 26 selects the electricity πₜ to be traded in each time slot by adopting, for example, a preference-based action selection method, and the formula is provided as follows:

$${π}_{t} ( a ) \dot{=} \frac{{e}^{{H}_{t} ( a )}}{{\sum }_{b = 1}^{k} {e}^{{H}_{t} ( b )}}$$

Herein, Hₜ(a) is a preference value of the action a at time t, and this preference value is updated in each time through the following formula:

H_{t+1,i}(a_{t,i})≙H_{t,i}(a_{t,i})+δ(Costᵢ(t)−C̅o̅s̅t̅₁̅(̅t̅)̅)(1−πₜ(a_{t,i}))

H_{t+1,i}(a)≙H_{t,i}(a)+δ(Costᵢ(t)−C̅o̅s̅t̅ᵢ̅(̅t̅)̅)πₜ(a)), for all a≠a_{t,i}

Herein, C̅o̅s̅t̅ᵢ̅(̅t̅)̅ is an average cost of a past time slot, and δ is a step parameter.

With reference to the flow of FIG. 3, in step S310, the processor 26 may determine whether the estimated electricity costs converge to a predetermined interval. Herein, if it is determined that the estimated electricity costs do not converge, step S308 is performed again, and the processor 26 continues to execute the planning procedure to update the reinforcement learning table.

In contrast, if it is determined that the estimated electricity costs converge, it means that training of the reinforcement learning table is completed, and the reinforcement learning table may be used for actual trading. At this time, step S312 is performed, and in actual trading, the processor 26 predicts trading electricity suitable to be arranged under a current power state by using the updated reinforcement learning table and uploads the trading electricity to the coordinator device 14 for trading. At this time, the cash flow, the electricity flow, and the data flow are generated.

It is noted that in some embodiments, after trading is performed, the processor 26 may, for example, further estimate the electricity costs of the trading electricity arranged in the current power state based on the simulated environment generated by the planning model and accordingly updates the reinforcement learning table. That is, the processor 26 may continuously update the reinforcement learning table by using actual trading results, such that the trading electricity estimated through the reinforcement learning table may be suitably applied to the real environment.

Through the foregoing method, since the reinforcement learning table is locally trained without communicating with the outside, the number of communications with an external apparatus may thus be reduced, and disadvantages of a conventional iterative bidding method may thus be improved.

It is noted that in some embodiments, in the apparatus for peer-to-peer energy sharing provided by the embodiments of the disclosure, the reinforcement learning table may be updated by adopting the model-based federated reinforcement learning method, such that variables in the defined power states are accordingly reduced, less memory space is used, and hardware requirement is lowered.

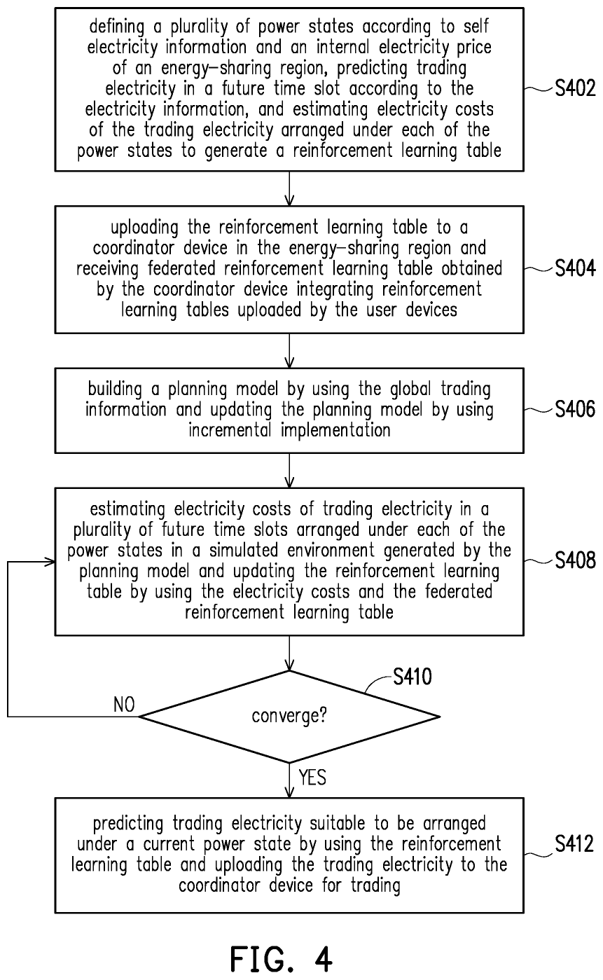

To be specific, FIG. 4 is a flow chart illustrating a method for peer-to-peer energy sharing based on reinforcement learning according to an embodiment of the disclosure. With reference to FIG. 1, FIG. 2, and FIG. 4 together, the method provided by this embodiment is adapted for the apparatus for peer-to-peer energy sharing 12-1, and the steps of the method for peer-to-peer energy sharing provided by this embodiment is described in detail below together with the devices of the apparatus for peer-to-peer energy sharing 12-1.

In step S402, the processor 26 of the apparatus for peer-to-peer energy sharing 12-1 defines a plurality of power states according to self electricity information and an internal electricity price of the energy-sharing region, predicts trading electricity in a future time slot according to the electricity information, and estimates electricity costs of the trading electricity arranged under each of the power states to generate a reinforcement learning table.

To be specific, different from the model-based multi-agent reinforcement learning disclosed in FIG. 3, in this embodiment, the processor 26 defines, for example, a state s_{t,i} of the i^{th} user device in the time slot t as:

s_{t,i}=[ξₛₑₗₗ(t−1),E_{b,i}(t−1),P_{c,i}(t),P_{renewable,i}(t)]

Herein, the parameter ξₛₑₗₗ(t−1) is the internal electricity price of the energy-sharing region, E_{b,i}(t−1) is stored electricity (i.e., battery electricity) of the i^{th} user device, P_{c,i}(t) is consumed electricity of the i^{th} user device, and P_{renewable,i}(t) is generated electricity of the i^{th} user device. That is, compared to the states defined in the embodiment of FIG. 3, in the state s_{t,i} provided by this embodiment, the variable of Pₙₑₜ^{agg}(t−1) is omitted, and the federated reinforcement learning table to be provided later is used instead to act as a learning target, so that computing performance may be accordingly improved.

In step S404, the processor 26 uploads the reinforcement learning table to the coordinator device 14 in the energy-sharing region, and receives the federated reinforcement learning table obtained by the coordinator device 14 integrating reinforcement learning tables uploaded by all user devices 12-1 to 12-n by using the connection device 22.

In an embodiment, the coordinator device 14, for example, averages the reinforcement learning tables Qᵢ( [symbol] ) uploaded by all user devices 12-1 to 12-n to obtain the federated reinforcement learning table Q_{f}( [symbol] ), and the formula is provided as follows:

$${Q}_{f} ( \cdot , \cdot ) = \frac{{\sum }_{i = 1}^{n} {Q}_{i} ( \cdot , \cdot )}{n}$$

In step S406, the processor 26 builds a planning model by using the “global trading information” returned by the coordinator device 14 and performs updating by using incremental implementation. The planning model is configured to accelerate learning and may reduce the number of communication cycles to two. Building and updating of the planning model are identical to those provided in the foregoing embodiment, and detailed description is thus omitted herein.

In step S408, in the simulated environment generated by the planning model, the processor 26 executes a planning procedure to estimate electricity costs of trading electricity in a plurality of time slots arranged under the power states and updates the reinforcement learning table by using the electricity costs and the federated reinforcement learning table. Herein, the updated formula of a learning value Qᵢ of the reinforcement learning table of the i^{th} user device is provided as follows:

$${Q}_{i} ( {s}_{t , i} , {a}_{t , i} ) ← ( 1 - α ) \cdot {Q}_{i} ( {s}_{t , i} , {a}_{t , i} ) + α \cdot \{ {Cost}_{i} ( t ) + γ \cdot {max}_{a} {Q}_{f} ( {s}_{t + 1 , i} , a ) \}$$

Herein, α is the learning rate, γ is the discount factor, Q_{f}(s_{t+1,i}, a) is the learning value of the federated reinforcement learning table obtained from the coordinator device 16 when the trading electricity a is arranged under the power state s_{t+1,i}. Among the plural types of trading electricity a which may be arranged in the power state s_{t,i}, the trading electricity a having the maximum learning value acts as the optimal trading electricity a*, and estimated electricity cost Costᵢ(t) of arranging this optimal trading electricity a* to the new power state s_{t+1,i} is fed back to the learning value of the trading electricity a corresponding to the original power state s_{t,i}. The learning rate α is, for example, any number between 0.1 and 0.5 and may be used to determine an influence ratio of the new power s_{t+1,i} to the learning value of the original power state s_{t,i}. The discount factor γ is, for example, any number between 0.9 and 0.99 and may be used to determine a ratio of the learning value of the new power state s_{t+1,i} to the fed-back electricity costs Costᵢ(t).

In step S410, the processor 26 may determine whether the estimated electricity costs converge to a predetermined interval. Herein, if it is determined that the estimated electricity costs do not converge, step S408 is performed again, and the processor 26 continues to execute the planning procedure to update the reinforcement learning table.

In contrast, if it is determined that the estimated electricity costs converge, it means that training of the reinforcement learning table is completed, and the reinforcement learning table may be used for actual trading. At this time, step S412 is performed, and in actual trading, the processor 26 predicts the trading electricity suitable to be arranged under the current power state by using the updated reinforcement learning table and uploads the trading electricity to the coordinator device 14 for trading. At this time, the cash flow, the electricity flow, and the data flow are generated.

It is noted that in some embodiments, after trading is performed, the processor 26 may, for example, further estimate the electricity costs of the trading electricity arranged in the current power state based on the simulated environment generated by the planning model and accordingly updates the reinforcement learning table by using the electricity costs and the federated reinforcement learning table. That is, the processor 26 may continuously update the reinforcement learning table by using the actual trading results, such that the trading electricity predicted through the reinforcement learning table may be suitably applied to the real environment.

Compared to the method provided in the embodiment of FIG. 3, in the method provided by this embodiment, the variable of global trading information is omitted when the reinforcement learning table is generated. As such, data of the power states is reduced by one dimension, thus the memory space required to store the reinforcement learning table is reduced, and computing cost for updating the reinforcement learning table is lowered as well. Therefore, hardware requirement is effectively lowered, which may facilitate development of the energy-sharing region.

In view of the foregoing, in the method and apparatus for peer-to-peer energy sharing based on reinforcement learning provided by the embodiments of the disclosure, the model-based method for multi-agent reinforcement learning and the federated reinforcement learning method are respectively provided for the purpose of achieving optimal performance and lowering user equipment requirement. Herein, since the reinforcement learning table is locally trained without communicating with the outside, the number of communications with an external apparatus may thus be reduced, and disadvantages of the conventional iterative bidding method may thus be improved. In addition, the c-greedy method or the like is adopted to introduce different solutions when the reinforcement learning table is updated, such that the optimal solution is prevented from falling into the local minimum, and the predicted trading electricity may thus be suitably applied to the real environment.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for peer-to-peer energy sharing based on reinforcement learning adapted to determine trading electricity by a designated user device among a plurality of user devices in an energy-sharing region, the method comprising:
uploading trading electricity in a future time slot predicted according to electricity information of the designated user device to a coordinator device in the energy-sharing region and receiving global trading information obtained by the coordinator device integrating trading electricity uploaded by each user device;
defining a plurality of power states according to the global trading information, the electricity information, and an internal electricity price of the energy-sharing region and estimating electricity costs of the trading electricity arranged under each of the power states to generate a reinforcement learning table;
building a planning model by using the global trading information and updating the planning model by using incremental implementation;
estimating electricity costs of trading electricity in a plurality of future time slots arranged under each of the power states in a simulated environment generated by the planning model to update the reinforcement learning table until the estimated electricity costs converge to a predetermined interval; and
predicting trading electricity suitable to be arranged under a current power state by using the reinforcement learning table and uploading the trading electricity to the coordinator device for trading.

2. The method according to claim 1, wherein the step of updating the reinforcement learning table comprises:
selecting an optimal solution of the trading electricity based on a specific probability and randomly selecting other solutions of the trading electricity based on a remaining probability to update the reinforcement learning table.

3. The method according to claim 1, wherein the trading electricity comprises purchased electricity or sold electricity, and the global trading information comprises a sum of electricity sales and a sum of electricity purchases of all of the user devices.

4. The method according to claim 1, wherein the electricity information comprises generated electricity, consumed electricity, and stored electricity.

5. The method according to claim 1, wherein after the step of predicting the trading electricity suitable to be arranged under the current power state by using the reinforcement learning table and uploading the trading electricity to the coordinator device for trading, the method further comprises:
estimating electricity costs of the trading electricity arranged under the current power state in the simulated environment generated by the planning model to update the reinforcement learning table.

6. A method for peer-to-peer energy sharing based on reinforcement learning adapted to determine trading electricity by a designated user device among a plurality of user devices in an energy-sharing region, the method comprising:
defining a plurality of power states according to self electricity information and an internal electricity price of the energy-sharing region, predicting trading electricity in a future time slot according to the electricity information, and estimating electricity costs of the trading electricity arranged under each of the power states to generate a reinforcement learning table;
uploading the reinforcement learning table to a coordinator device in the energy-sharing region and receiving a federated reinforcement learning table and a global trading information obtained by the coordinator device by integrating reinforcement learning tables uploaded by the user devices;
building a planning model by using the global trading information and updating the planning model by using incremental implementation;
estimating electricity costs of trading electricity in a plurality of future time slots arranged under each of the power states in a simulated environment generated by the planning model and updating the reinforcement learning table by using the electricity costs and the federated reinforcement learning table until the estimated electricity costs converge to a predetermined interval; and
predicting trading electricity suitable to be arranged under a current power state by using the reinforcement learning table and uploading the trading electricity to the coordinator device for trading.

7. The method according to claim 6, wherein the step of updating the reinforcement learning table further comprises:
selecting an optimal solution of the trading electricity based on a specific probability and randomly selecting other solutions of the trading electricity based on a remaining probability to update the reinforcement learning table.

8. The method according to claim 6, wherein the federated reinforcement learning table is an average of the reinforcement learning table of the user device.

9. The method according to claim 6, wherein the electricity information comprises generated electricity, consumed electricity, and stored electricity.

10. The method according to claim 6, wherein after the step of predicting the trading electricity suitable to be arranged under the current power state by using the reinforcement learning table and uploading the trading electricity to the coordinator device for trading, the method further comprises:
estimating electricity costs of the trading electricity arranged under the current power state in the simulated environment generated by the planning model and updating the reinforcement learning table by using the electricity costs and the federated reinforcement learning table.

11. An apparatus for peer-to-peer energy sharing based on reinforcement learning, comprising:
a connection device, configured to connect a coordinator device, wherein the coordinator device is configured to manage a plurality of user devices in an energy-sharing region and the apparatus for peer-to-peer energy sharing;
a storage device, configured to store a computer program; and
a processor, coupled to the connection device and the storage device, and configured to load and execute the computer program for:
defining a plurality of power states according to at least one of electricity information of the apparatus for peer-to-peer energy sharing, an internal electricity price of the energy-sharing region, and global trading information received from the coordinator device, predicting trading electricity in a future time slot according to the electricity information, and estimating electricity costs of the trading electricity arranged under each of the power states to generate a reinforcement learning table, wherein the global trading information is obtained by the coordinator device integrating trading electricity uploaded by each of the user devices;
building a planning model by using the global trading information and updating the planning model by using incremental implementation;
estimating electricity costs of trading electricity in a plurality of future time slots arranged under each of the power states in a simulated environment generated by the planning model and updating the reinforcement learning table by using at least one of the electricity costs and a federated reinforcement learning table until the estimated electricity costs converge to a predetermined interval, wherein the federated reinforcement learning table is obtained by the coordinator device integrating reinforcement learning tables uploaded by each of the user devices; and
predicting trading electricity suitable to be arranged under a current power state by using the reinforcement learning table and uploading the trading electricity to the coordinator device for trading.

12. The apparatus for peer-to-peer energy sharing according to claim 11, wherein the processor selects an optimal solution of the trading electricity based on a specific probability and randomly selects other solutions of the trading electricity based on a remaining probability to update the reinforcement learning table.

13. The apparatus for peer-to-peer energy sharing according to claim 11, wherein the trading electricity comprises purchased electricity or sold electricity, and the global trading information comprises a sum of electricity sales and a sum of electricity purchases of all of the user devices.

14. The apparatus for peer-to-peer energy sharing according to claim 11, wherein the federated reinforcement learning table is an average of the reinforcement learning tables of the user devices.

15. The apparatus for peer-to-peer energy sharing according to claim 11, wherein the electricity information comprises generated electricity, consumed electricity, and stored electricity.

16. The apparatus for peer-to-peer energy sharing according to claim 11, wherein the processor estimates electricity costs of the trading electricity arranged under the current power state in the simulated environment generated by the planning model and updates the reinforcement learning table by using at least one of the electricity costs and the federated reinforcement learning table.
